(19) United States
(12) Patent Application Publication
(10) Pub. No.: US 2022/0110001 A1
(43) Pub. Date: Apr. 7, 2022

(54) Method and Apparatus for Design of a Wireless Network

(71) Applicant: Sail Internet, Inc., Fremont, CA (US)

(72) Inventors: Georgios Ginis, San Mateo, CA (US); Kevin Dean Fisher, Palo Alto, CA (US)

(73) Assignee: Sail Internet, Inc., Fremont, CA (US)

(21) Appl. No.: 17/311,654

(22) PCT Filed: Dec. 3, 2019
(86) PCT No.: PCT/US19/64322

§ 371 Date: Jun. 7, 2021

Related U.S. Application Data
(60) Provisional application No. 62/777,671, filed on Dec. 10, 2018.

(51) Int. Cl. H04W 16/18

(52) U.S. Cl. CPC H04W 16/18

(57) ABSTRACT

A method for designing a wireless network generally involves identifying a site location as a candidate for a base-station installation, generating an analysis of the identified site location characterizing suitability for the base-station installation, and generating a decision to install a base-station at the identified site location based on the generated analysis.

### CROSS-REFERENCE TO RELATED APPLICATIONS

This application claims the benefit of U.S. provisional patent application No. 62/777,671, filed Dec. 11, 2018, entitled “Method and Apparatus for Design of a Wireless Network.” This application is related to International application no. PCT/US2019/039617, filed Jun. 27, 2019, entitled “Method and Apparatus for Qualifying Customers and Designing a Fixed Wireless Network using Mapping Data”, the entire contents of which are incorporated herein by reference.

### TECHNICAL FIELD

The present invention relates to the field of wireless internet access, and in particular to designing a wireless network.

### BACKGROUND

### Wireless Internet Access

Internet access is increasingly being delivered wirelessly. Mobile wireless internet access is directly delivered to mobile devices, such as smartphones, tablets and laptops. Fixed wireless internet access is delivered to residences and businesses via customer-side wireless equipment installed at fixed locations.

It is common for wireless internet access to use a cellular network architecture. In such an architecture, the total service area is divided into land areas called cells. Each cell is served by one base transceiver station or base-station. (In certain architectures, a cell can be served by multiple base-stations.) Base-stations communicate in both the downlink (from base-station to customer-side devices) and the uplink (from customer-side devices to base-station) directions with the customer-side devices. Base-stations also have backhaul connections to the core network that further connects to the internet.

For mobile wireless internet access, base-stations are part of the infrastructure of the mobile network operator. In the Universal Mobile Telecommunications System (UMTS, also known as 3G), a mobile cellular system for networks based on the GSM standard, and the 3GPP Long Term Evolution (LTE, also known as 4G) mobile communications standard, the base-station is known as the Node B and eNodeB correspondingly, and the mobile device is known as the user equipment (UE). In 5G specifications, the base-station is known as the Next Generation NodeB or gNB. For fixed wireless internet access, base-stations are part of the infrastructure of the wireless internet service provider (WISP). The base-station may also be called an Access Point, a Point-to-MultiPoint (PtMP) radio, or a Base Unit (BU). The customer-side device may be called a Station, a client radio, or a Terminal Unit (TU). Also, for fixed wireless internet access, the term Access Point coverage area may be used instead of the term cell.

### Wireless Network/Cellular System Design

Cellular systems exploit the fact that wireless signals attenuate as they propagate in space. As a result, the same signal frequency (or time slot, or code) can be reused at sufficiently distant locations. In cellular system designs, each cell is assigned its own set of frequencies (or time slots, or codes). Cells with sufficient distance between them can reuse the same frequencies (or time slots, or codes).

Theoretical models of cellular systems assume that cells are non-overlapping hexagons with the base-station located at the center of each hexagon. The example of FIG. 1 [source: en.wikipedia.org/wiki/Cellular_network] shows how frequencies F1, F2, and F3 are reused among a set of cells 100-135. In this figure, there are three cells, 100, 110, and 130 that use the same frequency F1. The amount of inter-cell interference among these cells depends on the distance between them. A goal of system design is to keep such inter-cell interference sufficiently low.

Certain cellular systems use sectoring, where each cell is further divided into a number of sectors (e.g., 3 or 6). A single base-station still serves all of the cell's sectors; however, directional antennas narrow transmission and reception to the corresponding sector.

A second example of a cellular system is shown in FIG. 2 [source: www.pitt.edu/˜dtipper/2720/2720_Slides4.pdf]. In this system, cells are grouped in clusters of size 7, and each cell within a cluster is assigned a unique frequency. Frequencies are reused within clusters of 7 cells, so the design is said to have a frequency reuse factor of 7. Cells using the same frequency are spaced far apart to mitigate effects of inter-cell interference. For example, the cell 205 at the center of the cluster of cells 200 is assigned frequency “5”. There are 6 cells 210, 215, 220, 225, 230, and 235 (from the 6 clusters surrounding the cluster 200) also assigned frequency “5” and potentially introducing inter-cell interference.

Sectoring can further reduce inter-cell interference. If a different frequency is used for each sector, then inter-cell interference is introduced by only a subset of sectors. In FIG. 2, it is assumed that 120-degree sectoring is used (e.g., 120-degree sectors 240, 245 and 250), so that each cell is sub-divided into 3 sectors. The figure shows how sectoring reduces the number of neighboring cells that can potentially introduce inter-cell interference from 6 to 2.

In practice, cells are not hexagons. Terrain, vegetation and buildings affect signal propagation, which determines both the coverage provided by a base-station, and the interference caused to neighboring cells. The shapes of cells depend on these factors; these shapes may be non-symmetric around the base-station, they may contain “holes”, and they may even consist of “islands”, i.e., pieces that are disconnected. Furthermore, interference encountered in a cell that is caused by “neighboring” cells is not necessarily limited to cells that are adjacent to the cell. There is a potential for, or a possibility of, interference being encountered in a cell that is caused by a cell that is nonadjacent, or non-contiguous, with respect to the cell.

Traditional cell-based wireless networks consist of macro-cells, with each macro-cell serving an area of several square kilometers and encompassing thousands of customers. The selection of the base-station location is limited by the availability of towers or commercial buildings. Candidate base-station locations may be identified using cell-planning software, which typically takes into account only crude information about the terrain, vegetation and structures within the cell.

After candidate base-station locations have been identified, leasing agreements need to be made with the corresponding property owners. A new base-station may be installed at an existing tower, in which case an agreement must be negotiated and reached with the tower owner. If a new tower must be erected, there are substantial additional efforts related to permitting and construction. A new base-station may alternately be installed on the rooftop of a building, in which case an agreement must be negotiated and reached with the building owner. It is typical for such negotiation to be time-consuming.

Installing a new base-station also requires that appropriate permits be obtained. Such permitting can include requirements related to aesthetics, radio-frequency analysis, health and safety considerations, electrical design, mechanical design, and structural analysis. Permitting may also include public hearings and addressing concerns of the public.

In recent years, new mobile wireless network architectures have tried to make base-station installations more compact while improving wireless network coverage. For example, in a Distributed Antenna System (DAS), a network of antenna nodes installed at separate locations replaces the single antenna of the traditional base-station. The antenna nodes are connected to a head-end location, where the rest of the base-station is installed. Such architecture leads to a smaller antenna footprint at each location, and makes it possible for antenna nodes to be mounted on smaller buildings, or on street-lighting and utility poles. Each antenna node still requires a leasing agreement and the permitting process described above.

The installation of the base-station is a complex undertaking. Proceeding with an installation depends on being able to obtain power, and also depends on the availability of a backhaul connection. The installation project consists of several parts including construction, electrical work, hardware installation, antenna mounting and alignment, hardware configuration, and testing/verification.

In summary, the design of a wireless network based on macro-cells is a multi-step process. The overall process is time-consuming and labor-intensive. However, it is justified based on the expected benefits from serving thousands of mobile customers via this new macro-cell. It is reasonable to invest a significant amount of time and capital to select the base-station location, to acquire the necessary rights and permits, and to install the expensive base-station hardware.

### Interference in a Cellular System

Given the preceding description, sources of interference in a cellular system can be categorized, and the common techniques to prevent such interference can be described. FIG. 3 shows an example of a cellular system consisting of two base-stations, B1 and B2. User equipment (UE), or “Client”, devices C11, C12 and C13 belong to the cell of B1, and communicate in both the downlink and the uplink direction with B1. Clients C21, C22, and C23 belong to the cell of B2, and correspondingly communicate in both directions with B2.

The following types of interference can affect downlink communication (e.g. from B1 to C11):
Intra-cell (also known as in-cell) interference: Transmissions from clients, e.g., clients C12 and C13, which belong to the same cell as C11, may cause interference onto the signal received by another client in the same cell, e.g., C11. Such interference is typically mitigated using multiple-access techniques. Inter-cell (also known as out-of-cell) interference: Transmissions from clients in one cell area, e.g., clients C21, C22 and C23, and also from the base-station B2 in the same cell area, may cause interference onto the signal received by clients in a different, neighboring cell area, e.g., clients C11 (or C12 or C13). Such interference is typically prevented by assigning a different frequency (or time slot or code) to neighboring cells.
Self-interference: Transmissions from a client, e.g., client C11, itself may cause interference onto the signal received by C11 itself. Such interference, which is also known as echo, is typically avoided using duplexing techniques, or with echo cancellation.

The same types of interference can affect uplink communication from a client in one cell area to a base station in the same cell area, e.g., from C11 to B1. These types of interferences are here only briefly listed:
Intra-cell (or in-cell) interference, e.g., from C12 and C13.
Inter-cell (also known as out-of-cell) interference, e.g., from C21, C22 and C23, and from B2.
Self-interference: From base-station B1 itself

An example scheme to reduce intra-cell, inter-cell and self-interference is described next based on the Spectrum Reuse Synchronization (SRS) technique used by Mimosa radio products operating in the 5 GHz band, available from Airspan Networks Inc.

In SRS, a base-station (or access-point) is using the same frequency for both downlink and uplink transmission. The multiple access technique is TDMA (or Time Division Multiple Access): a time window is split into slots, where a fixed percentage of time-slots is allocated to downlink and the remaining time-slots are allocated to uplink. The base-station uses downlink time-slots to transmit data destined for different clients. The base-station also allocates uplink time-slots to clients and informs them of this allocation. Clients only transmit during their allocated time-slots. This scheme eliminates intra-cell interference (only one among the base-station and the clients can transmit at any time), and self-interference (there can be no simultaneous downlink and uplink transmission at any given time).

Additionally, in SRS, all base-stations are synchronized to the Global Positioning System (GPS) clock, and synchronize their time windows, such that their downlink and uplink time-slots are aligned. Thus, reception of a signal at a base-station is not affected by interference from a neighboring base-station (e.g., B1 in FIG. 3 cannot receive interference from B2). Similarly, reception of a signal at a client is not affected by interference from a client in a neighboring cell (e.g., C11 cannot receive interference from C21, C22 or C23). This eliminates one type of inter-cell interference.

SRS does not eliminate the following type of inter-cell interference: reception of a signal at a base-station may be affected by interference from clients in neighboring cells (e.g., B1 may receive interference from C22). And reception of a signal at a client may be affected by interference from a neighboring base-station (e.g., C11 may receive interference from B2). This effect is mitigated by the fact that clients are using directional antennas. For such interference to have an impact, base-stations and clients have to be approximately co-linear (e.g., in FIG. 3, the line formed by B2 and C22 needs to approximately align with the line formed by B1 and C22; or the line formed by C11 and B1 needs to approximately align with the line formed by C11 and B2).

### Trends

Demands for higher wireless speeds, lower latency and higher density of connected devices are leading to two fundamental changes in the design of cellular systems:
A. Wireless systems must use larger amounts of radio frequency spectrum.
B. Wireless base-stations must be located closer to the user equipment, or the customer device.

As explained in more detail in International application no. PCT/US2019/039617, filed Jun. 27, 2019, entitled “Method and Apparatus for Qualifying Customers and Designing a Fixed Wireless Network using Mapping Data”, wireless internet access is increasingly using “mid-band” (3 to 6 GHz) or “high-band” (greater than 6 GHz) spectrum in either licensed or in unlicensed bands. 5G wireless systems are expected to additionally use higher frequencies, such as microwave frequencies above 3 GHz, and millimeter-wave (mmwave) frequencies (starting at 30 GHz). Wireless Internet Service Providers (WISPs) have traditionally used the 915 MHz, 2.4 GHz, and 5 GHz bands for their Access Points, but are expanding their use of the 24 GHz and 60 GHz bands.

The use of higher frequencies leads to larger attenuation of the radio signals for a given distance. This, combined with the needs for higher throughput, lower latency and higher connection density, requires shorter distances between base-stations and customer devices, and consequently requires more base-stations in each served area. For existing 4G wireless systems that use a cellular system architecture, the transition to 5G involves the addition of small cells with a smaller footprint than traditional macro-cells. This process of adding small cells to supplement existing macro-cells is known as densification. Similarly for WISPs, the use of higher frequencies requires denser networks of Access Points.

Additionally, the use of higher frequencies means that radio signals propagate mainly via line-of-sight (LOS) paths. Building walls and foliage mostly block radio signals operating at these higher frequencies. The presence of structures and vegetation can affect the area that can be reliably served by the base-station. The cell area is effectively equal to the area occupied by the viewshed of the base-station's antenna (i.e., the area visible from that antenna). Consequently, the resulting cell areas (or Access Point coverage areas) can be highly fragmented, especially if base-station antennas cannot be installed on very tall towers, but have to be mounted on structures, such as existing buildings, and utility or street-lighting poles.

The transition from macro-cells to small cells has deep implications on how cell-based networks are designed and built. Traditionally, macro-cells have sizes approximating a radius of 1 to 20 km, and are intended to serve several hundreds to thousands of customers. Each cell is served by a base-station at a tower or on top of a tall building. Antennas are physically large, and mounting several of them (to support sectoring or to support Multiple-Input Multiple-Output technologies) requires several meters of linear space on a tower. Other hardware such as waveguides, base-band units, and remote radio units are also bulky, thus increasing significantly the overall space required to install a base-station. The locations of macro-cell base-stations are constrained by the availability of tall towers, or the existence of buildings with the desired characteristics (e.g. availability of roof space). For such buildings, an additional requirement is having a leasing agreement between the property owner and the network operator. Backhaul connectivity is often provided via wired connections (e.g., fiber optic cabling). The design and installation of a macro-cell base-station is a major project with an estimated cost (in the US) on the order of $100,000 for hardware and labor. This estimate assumes installation at an existing tower or site. Costs escalate significantly if a new tower must be constructed.

On the other hand, small cells serve areas with an approximate radius of 200 m to 2 km, and are intended to serve tens of, or, at most, a few hundred, customers. Base-station hardware (including antennas) for small cellular service areas is small enough to mount at locations such as utility and street-lighting poles. In addition, base-stations can be placed on roofs of single-family homes, apartment/condominium buildings, office buildings, or other commercial buildings. Antenna transmitted power is orders of magnitude lower than in macro-cells, thus reducing powering requirements, and making compliance with emissions regulations much easier to achieve. Backhaul connectivity is much more often provided via wireless connections. The total cost of installing a small cell is in the order of $5000 (US dollars).

It is noted that in fixed wireless internet access applications, the location of a base-station (or of an access point) may be described with alternate names such as: relay site, relay node, hub site, and hub home.

### BRIEF DESCRIPTION OF THE DRAWINGS

FIG. 1 is a depiction of how frequencies are reused among a set of cells in a cellular system.

FIG. 2 is a depiction of another example of a cellular system using 120-degree sectoring.

FIG. 3 shows an example of a cellular system.

FIG. 4 is a flow chart depicting an embodiment of the invention.

FIG. 5A is a flow chart illustrating an embodiment of the invention.

FIG. 5B is a flow chart illustrating aspects of an embodiment of the invention.

FIG. 5C is a flow chart illustrating aspects of an embodiment of the invention.

FIG. 5D is a flow chart illustrating aspects of an embodiment of the invention.

FIG. 6 provides an example of a generated viewshed, in accordance with an embodiment of the invention.

FIG. 7 is an example of a first Fresnel zone in accordance with an embodiment of the invention.

FIG. 8 is an example of intersection of a viewshed and roof areas for 3 single-family homes.

FIG. 9A is a flow chart illustrating aspects of an embodiment of the invention.

FIG. 9B is a flow chart illustrating aspects of an embodiment of the invention.

FIG. 10 is a flow chart illustrating aspects of an embodiment of the invention.

FIG. 11 is a flow chart illustrating aspects of an embodiment of the invention.

FIG. 12 illustrates a graph as may be used in embodiments of the invention to implement connectivity metrics.

FIG. 13 illustrates an example of vertex-connectivity as may be used in embodiments of the invention to implement connectivity metrics.

FIG. 14 is a flow chart depicting an embodiment of the invention.

FIG. 15 is a flow chart depicting an embodiment of the invention.

FIG. 16 is a flow chart depicting an embodiment of the invention.

FIG. 17 is a flow chart depicting an embodiment of the invention.

FIG. 18 is a flow chart depicting an embodiment of the invention.

FIG. 19 depicts a blockchain as may be used in an embodiment of the invention.

FIG. 20 is a flow chart depicting an embodiment of the invention.

FIG. 21 illustrates an embodiment of the invention for selecting an area of a cell service area for relay sites.

FIG. 22 illustrates an embodiment of the invention for selecting an area of a cell service area for relay sites.

FIG. 23 shows an example of “corners” in a target service area being defined by physical features, such as road intersections.

FIG. 24 illustrates a diagrammatic representation of a machine in the exemplary form of a computer system, in accordance with one embodiment of the invention.

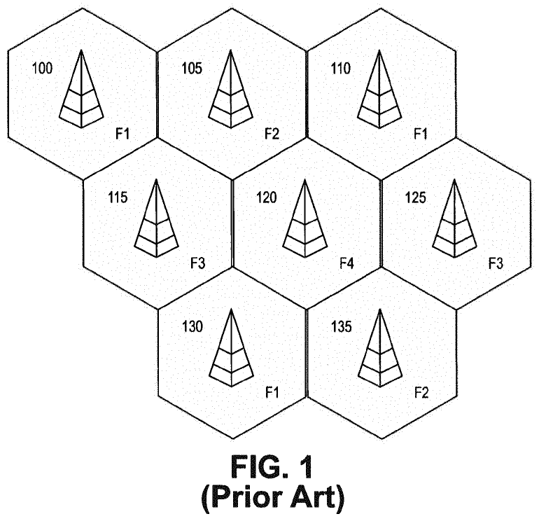

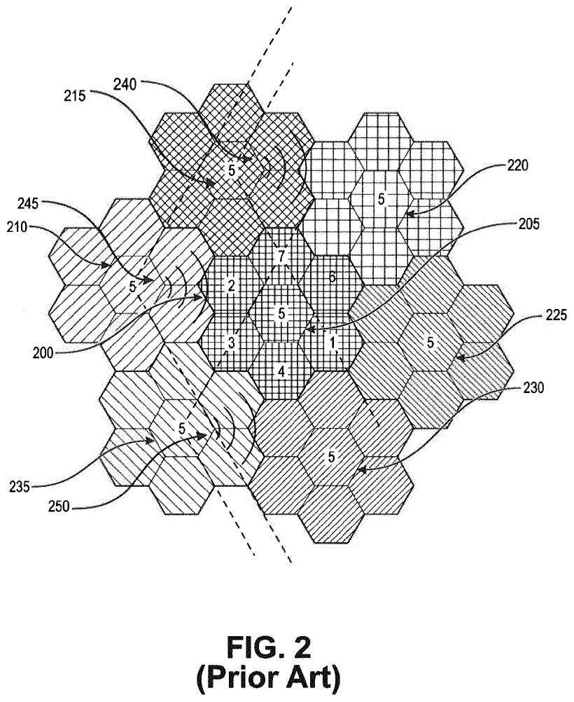

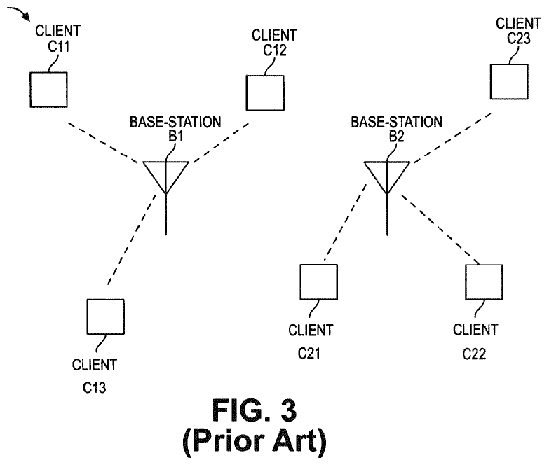

### DETAILED DESCRIPTION

The design of a wireless network based on small cells creates new challenges. To demonstrate these challenges, assume that small cells with a radius of 500 m need to be installed to replace a macro-cell with a radius of 2 km. Using a simplistic analysis, 16 small cells need to be installed, each serving approximately 1/16th of the customers previously served by the macro-cell. The actual number of small cells may well vary. Replicating the previous process to select and install a macro-cell site to now select and install 16 small-cell sites would be both expensive and inefficient. Additionally, in fixed wireless internet applications, it is often incorrect to assume that customers are uniformly distributed within an area: customer homes or businesses may be clustered, client devices are fixed on rooftops, and customers expect a consistent high-speed connection.

Embodiments of the invention provide new techniques to facilitate the design of wireless network based on small cells. Macro-cell network design uses the principle of “build it and they will come”. The small-cell network design techniques according to embodiments of the invention have the following characteristics:
they produce designs that align with customer interest;
they enable incremental network expansion; and
they allow a simpler process of acquiring rights for base-station locations.

### Integrated Method for Network Design and Site Acquisition

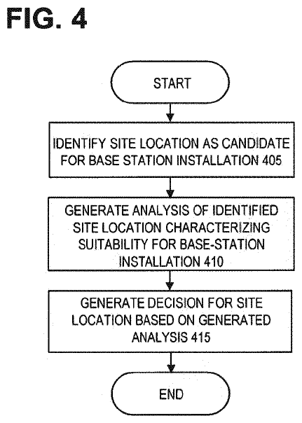

In general, and with reference to FIG. 4, embodiments of the invention involve the following steps:
identify site location as a candidate for base-station installation at step 405;
generate analysis of the identified site location characterizing suitability for base-station installation at step 410; and
generate a decision to install, or not install, a base-station at the site location based on the generated analysis at step 415.

The first step, 405, of identifying the site location can be triggered by an action such as a site owner signing up on a website, or the site owner expressing interest through an alternative communication channel. In the second step, 410, of generating an analysis, such generation can be performed on-demand, or an analysis may have been previously generated, in which case it is retrieved from data storage. Generating, at step 415, a decision about the site location concerns whether base-station installation should proceed on that site. These general steps are discussed below.

Identifying a Site Location 405

When planning to serve a new area (“greenfield”), the service provider may launch a marketing or advertising campaign to reach potential customers and also potential relay site owners within the new area. Such campaigns may include electronic means, e.g., targeted internet advertising, or may include more traditional means, e.g., post-cards, and door-hangers. Campaigns may be direct from the service provider to the customers. Campaigns may also be indirect, such as existing customers or site owners or neighbors inviting potential customers and site owners.

Finally, such campaigns can be launched in currently served areas, but where additional sites need to be identified for expanding coverage or for improving service (“densification”).

Potential customers within an area can be identified from both public and private databases, such as parcel maps, and real-estate data. Potential relay site owners within an area can also be identified from public and private databases but can be further qualified based on the viewshed ranking of their locations. (The viewshed of a location is the number of properties, at least some portion of which can be viewed unobstructed from the location, which can be translated into the number of potential customers that can be served from the location using line-of-sight wireless technologies.)

Potential customer and site owners can then reach out to the service provider to express interest in signing up for service or in becoming a relay (or base-station) site. This can be accomplished via various communication channels, such as a website or a web-service, where customers or site owners can register and provide their information.

The process of “inviting” a site owner to register can be facilitated by means such as sending to the site owner (either electronically or in printed material) a code that uniquely identifies the site location. The site owner can use the code to expedite the registration process. The registration process may include a verification of the provided information. For example, the site owner may be asked to provide a phone number, credit card information, or certain digits of a Social Security Number, which can then be compared with available records to validate address or other information of the site owner.

The registration of a site owner clearly identifies the corresponding site location as a candidate for base-station installation.

Customer Qualification Using Digital Surface Model (DSM) and Roof Identification Data

At its simplest, customer qualification answers the question: can base-station B serve customer C? For fixed wireless communications service applications, customer C always maps to a physical address, which corresponds to a parcel. It is reasonable to expect this parcel to have a building, on which roof (or similar space) the antenna equipment needs to be installed.

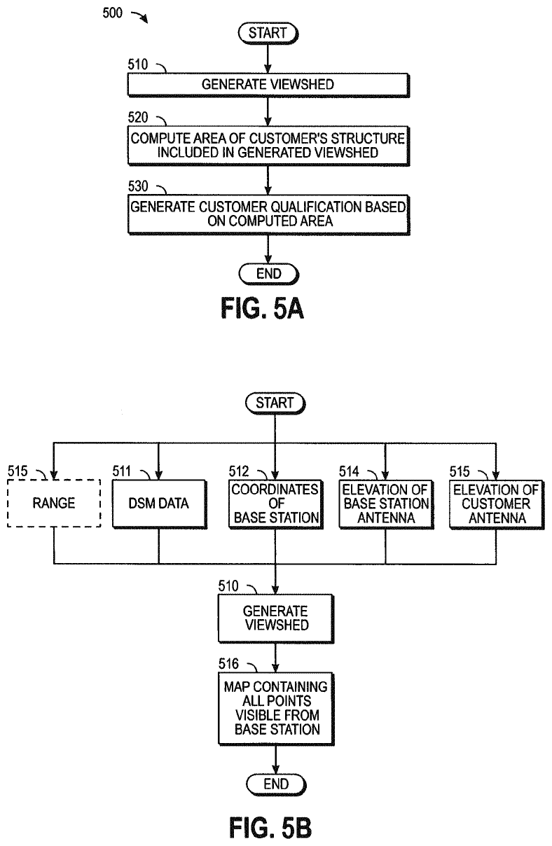

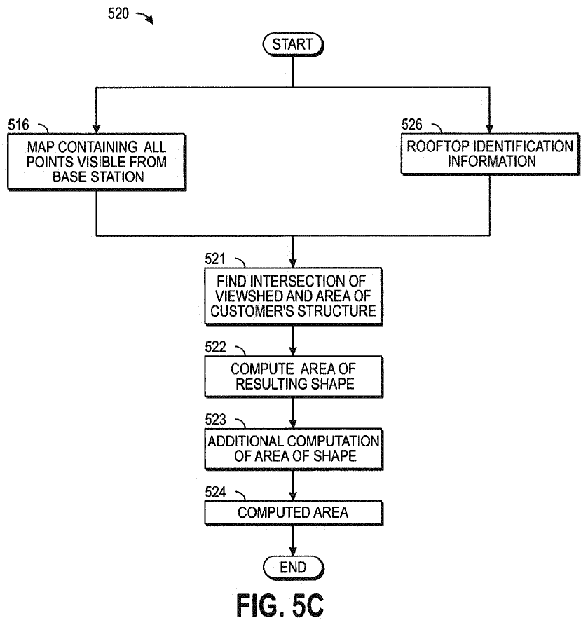

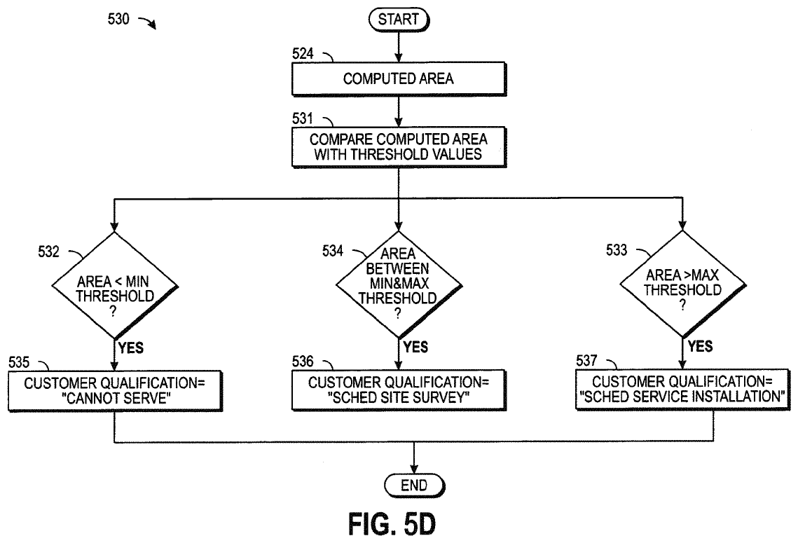

The customer qualification steps are as follows, with reference to the flowcharts in FIGS. 5A-5D, according to an embodiment 500:
1. Generate the viewshed of base-station B at step 510;
2. Compute at step 520 the area of customer C's structure (e.g., rooftop) that is included in the generated viewshed of step 510; and
3. Produce at step 530 the customer qualification result based on computed area in step 520.

With regard to FIG. 5B, viewshed generation 510 requires as input the DSM data at 511. It also requires the two-dimensional coordinates of the base-station at 512, and the height or elevation of the base-station antenna 513. The height or elevation of customer antenna 514 (relative to DSM data) is an optional parameter that may be input for viewshed generation. In one embodiment, the height of antenna 513 or the height of antenna 514 is relative to the structure (e.g., roof) on which it is mounted, or, in another embodiment, relative to some other point of reference, such as sea level. An additional, optional, parameter (reducing the required computation) that may be input is the range 515, which limits the maximum distance for computing Line of Sight (LOS). The output of viewshed generation, according to one embodiment, is a map 516 containing all points that are visible from the base-station that may or may not be limited by a maximum distance for LOS, according to the embodiment. In an alternative embodiment, the output can be other than a map, for example, a set of coordinate pairs defining polygons of areas that are visible from the base station, a raster file (e.g., 0/1 value for every pixel of the map to indicate if the corresponding coordinates are in the viewshed or not), or a vector file (e.g., a file containing polygon representations as a list of vectors, where the union of the polygons is equal to the viewshed).

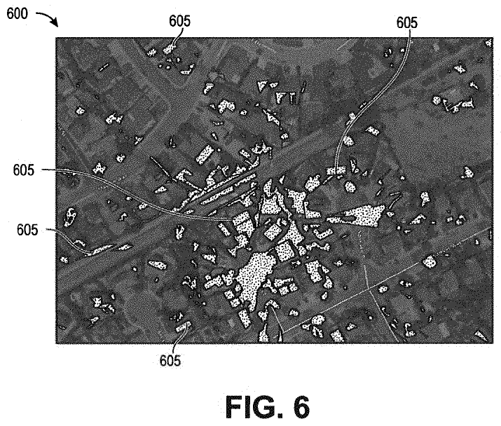

An example of a map of a generated viewshed is shown at 600 in FIG. 6, where the areas 605 indicate all points that are visible by a base-station at the location of the pin.

Viewshed computation is a relatively intensive process. For a map with n points (or cells), a brute-force algorithm requires O(n\hat{ }(3/2)) LOS tests to be performed. The more sophisticated “sweep-line” algorithms requires O\hat{ }(n*log n) tests. Some algorithm designs make use of GPU parallelization to significantly accelerate viewshed generation. See r.viewshed algorithm described at “grass.osgeo.org\\grass74\\manuals\\r.viewshed.html”, developed by Toma, L., Zhuang, Y., Richard, W., and Metz, M., and source code available at “trac.osgeo.org/grass/browser/grass/trunk/raster/r.viewshed”; and Fang Chao, Yang Chongjun, Chen Zhuo, Yao Xiaojing & Guo Hantao (2011), Parallel algorithm for viewshed analysis on a modern GPU, Int. J. Digital Earth. Vol. 4, Issue 6. pp. 471-486; and Heilmair, Christoph, GPU-based visualisation of viewshed from roads or areas in a 3D environment, Master of Science Thesis in Electrical Engineering, Linköping University, Sweden, 2016, LiTH-ISY-EX—16/4951—SE (at liu.diva-portal.org/smash/get/diva2:954165/FULLTEXT01.pdf).

The viewshed is a very useful yet approximate method of estimating whether a signal can propagate without obstructions between a base-station antenna and a customer antenna. In practice, obstructions near the LOS path can further affect signal propagation. Objects near the LOS path will deflect a transmitted signal and its reflection may reach the receiver (whether in the downlink or uplink direction). Such reflected signals may combine constructively or destructively with the “direct” LOS signal, and result in a stronger or weaker received signal. The degree to which a reflected signal combines constructively or destructively with the direct signal depends on the phase of the reflected signal relative to the direct signal. For example, if the direct signal and a reflected signal of opposite phase combine at the receiver, the combined signal will be weaker than the direct signal on its own. The two (direct and reflected) signals may nearly cancel each other out if the distances they travel are similar.

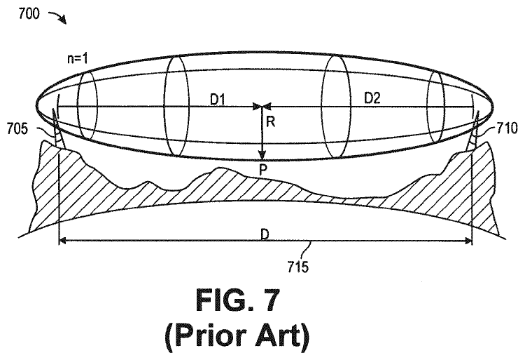

The concept of Fresnel zones captures the effect of obstacles near the LOS path on signal propagation. The first Fresnel zone is an ellipsoidal region of space surrounding the antennas of the wireless system. If a transmitted signal is reflected by an object on the boundary of the first Fresnel zone and continues on to the receiver, it undergoes a phase shift of half a wavelength. An example of a first Fresnel zone obtained from an illustration at //en.wikipedia.org/wiki/Fresnel_zone and shown at 700 in FIG. 7, where the distance between the two antennas 705 and 710 is D, at 715.

Objects within the first Fresnel zone can cause reflected signals with a certain risk of those signals having such phase at the receiver that the combined signal is attenuated. As a result, the first Fresnel zone should, ideally, be free of obstructions in wireless systems with LOS requirements. Various rules may be followed, for example where some degree of obstruction may be tolerated (e.g. 20%). Higher order Fresnel zones are defined based on the phase shift caused by an object on their outer boundaries: the second Fresnel zone corresponds to a phase shift of one wavelength, the third Fresnel zone corresponds to a phase shift of 1.5 wavelengths, etc.

The definition of viewshed can be extended, and the above described algorithms modified, to take into account Fresnel zones. In particular, one embodiment contemplates a modified “viewshed” generation algorithm that instead of LOS computes a “clear 1st Fresnel zone” or “X % clear 1st Fresnel zone”. In the standard definition of viewshed, point C is assumed visible by point B if a straight line can be drawn between them without crossing any obstacle in the intervening three-dimensional space. In an extended definition of viewshed with application to fixed wireless systems, point C is defined as “visible” by point B if the first Fresnel zone (corresponding to antennas placed at points B and C, and with a certain assumed transmission) is free of any obstacles. Variations of this definition may require that the first Fresnel zone is obstructed by less than a certain threshold, or that higher-order Fresnel zones are (relatively) free of obstructions.

The definition of viewshed can also be extended to take into account the radiation pattern of the base-station antenna. “Sector” antennas have a radiation pattern in the horizontal plane that favors a certain range of angles. This behavior is in contrast to “omni-directional” antennas whose radiation pattern in the horizontal plane is essentially flat. The generated viewshed can take the antenna pattern into account and exclude from its illuminated areas those corresponding to angles where the radiation pattern is weak or falls below a threshold. This method can be applied to both the vertical and the horizontal planes.

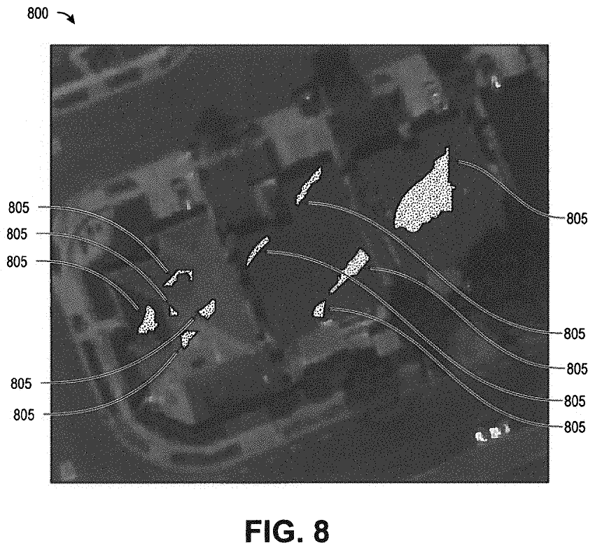

With reference to FIGS. 5A and 5C, the second step (at 520) of customer qualification is computing the area of customer C's rooftop that is included in the generated viewshed. Step 520 includes, in one embodiment, the steps 521-524 set forth in FIG. 5C. Step 521 involves finding the intersection of the viewshed for the base-station and the relevant area of the customer's structure (e.g., the roof area of customer's building) based on input including the viewshed (i.e., a map containing all points visible from the base-station 516), and rooftop identification information 526, and then computing the area of the resulting shape at step 522. This resulting shape can be non-compact (may contain “holes”) and non-connected or dis-contiguous (may consist of “islands”). See FIG. 8 for an example of the intersections 805 of viewshed and roof areas for 3 single-family homes at 800. Additional processing of the geographical data is possible to improve the algorithm accuracy, at step 523. A first example of such processing is to reduce or shrink the shape resulting from the intersection operation to produce a more conservative estimate of the illuminated area (as performed, according to one embodiment, by the v.buffer function of GRASS with a negative “buffer” value). A second example is to eliminate small islands or dis-contiguous elements or regions of the resulting shape, so that such islands, elements, or regions do not count toward the estimated area of the shape. In one embodiment, step 523 may be performed after computing the area of the resulting shape at step 522. In another embodiment, these steps may be performed in reverse order.

With reference to FIGS. 5A and 5D, the final step 530 of customer qualification is to produce the customer qualification result based on computed area. One method to produce this result, according to one embodiment, is to compare the computed area with certain threshold values at step 531. If the computed area is below a first threshold (e.g. 5 square meters) at 532, then the customer qualification result is a recommendation at step 535 such as “cannot serve”. If the computed area is above a second threshold (e.g. 20 square meters) at 533, then the result is a recommendation at step 537 to “schedule service installation”. If the computed area has a value between the two thresholds at 534, then the result is a recommendation at step 536 to “schedule site survey”. For the latter case, the purpose of the site survey might be to provide a more definite answer as to whether the customer can be served or not.

Further criteria and more complex logic can be added to step 530. One additional criterion is to check the distance between the base-station and the roof area, and to disqualify (recommend as “cannot serve”) those customers with a distance exceeding a certain threshold. This check can be made dependent on the type of installed base-station or on the type of planned customer-side radio. A more complex logic is to make the thresholds used for comparing areas at step 531 dependent on the distance between the base-station and the roof area. Another embodiment contemplates making these area thresholds dependent on the type of the installed base-station or on the type of planned customer-side radio.

The customer qualification result can have multiple fields of information. It typically contains a recommendation such as “install”, “survey”, “cannot serve” as explained above. It may also include information about areas identified for antenna installation or about one or more preferred locations for such installation, e.g. “mount antenna at coordinates (X,Y); chimney”. It may provide data, such as the computed area of the viewshed-illuminated part of the roof, the distance between the base-station and the customer-side antenna location, the compass bearing for aligning the customer-side antenna to the base-station, estimated antenna tilt angle, expected received signal strength and expected transmission speeds.

The customer qualification method can be used in various modes. A first mode is to execute a check of whether a specified base-station B can serve a specified customer C.

A second mode is to execute a check of whether any base-station (among a set of installed base-stations B_1, B_2, . . . , Bn) can serve a specific customer C. A standard implementation of this second mode is to iterate over base-stations B_1, B_2, . . . , B_n and to invoke for each iteration the customer qualification method as defined in the first mode. This case produces a separate qualification result for each base-station. Using the individual qualification results for each base-station, one can then produce a combined qualification result. For example, if base-station B_2's viewshed illuminates the largest roof-top area of customer C among all base-stations, the combined qualification result can be “Proceed with service installation using base-station B_2”.

A third mode is to execute a search for all customers (corresponding to locations or parcels within a defined region) that can be served by a specific base-station B. An implementation of this third mode may start with the viewshed generation for base-station B and proceed with the computation of the viewshed-illuminated roof area for each of the customer locations. The customer qualification result is then produced for each customer individually based on this computed area.

A fourth mode is to produce customer qualification results for all customers and against all base-stations within a defined region. The implementation of this mode can include iteration over all installed base-stations. For each iteration the viewshed is generated for the corresponding base-station, the viewshed-illuminated roof area is computed for each and every customer location, and the customer qualification result is produced for each and every customer location and the corresponding base-station. A combined customer qualification result may additionally be produced similarly to what was described above for the second mode.

In summary, the steps for an embodiment of customer qualification are as follows, keeping in mind that not all steps are necessary in all embodiments:
1. Generate viewshed of base-station B at step 510;
2. Produce intersection of base-station viewshed and identified roof areas at step 521;
3. Process intersection (e.g., eliminate small “islands”, shrink individual areas) at step 523; and
4. Find all parcels P (i.e., customer locations) that overlap with the intersection produced and processed at steps 521, 523;
5. Estimate area of intersection within a parcel P at step 522, and output the estimated (computed) area 524;
6. If estimated area 524 is determined at step 531 is below a first threshold T1 at step 532, store a result that indicates the fixed wireless communication system “Cannot serve parcel P from base-station B” at step 535;
7. If estimated area 524 is above a second threshold T2 at 533, store the result that indicates the system “Can install service to parcel P from base-station B” at step 537;
8. If estimated area 524 is between thresholds T1 and T2 at 534, store the result that indicates the system needs to “schedule a site survey to decide if parcel P can be served from base-station B” at step 536;
9. Is there another parcel that overlaps with intersection? If Yes, go to 5 (step 522), if No, go to 10 (next step);
10. Is there another base-station in the region? If Yes, go to 1 (step 510), if No, then end.

Generating Analysis of Site Location 410

Several techniques for analyzing site locations are described below.

Embodiments of the invention may utilize a network design method described below to evaluate and rank candidate locations for installing new base-stations providing for fixed wireless communications with customers. The embodiments use objective metrics to estimate the attractiveness of each location, and are capable of producing candidate “designs” that include multiple base-stations to serve customers in a target area.

An initial requirement for the network design method is to identify a target area to serve. Marketing data such as demographics, information about competitors, and expressed interest by potential customers can be factors in such a decision. Other considerations such as availability of internet backbone connections, regulatory criteria, terrain, building density and vegetation density can be additional factors.

The fundamental steps of network design, according to one embodiment of the invention, are as follows:
1. Evaluate each candidate location for installing a new base-station; and
2. Produce ranking of evaluated candidate locations.
   Evaluation of candidate locations for installing a new base-station

Any parcel of land can be a candidate location for installing a new base-station. For the purpose of building a fixed wireless network in a suburban or urban environment, parcels containing buildings are preferable in that the building provides good options for installing one or more base-station antennas at a good height without requiring new construction. The method described herein according to one embodiment identifies base-station candidate locations based on the parcel where the base-station may be installed.

It is desirable for a new base-station to be able to serve many potential customers, or even better, to serve customers that have already expressed an interest in being served. Fixed wireless customers can be identified based on the parcel of their residence or business.

Each base-station is characterized by the customer locations that it can serve. These locations are determined by the viewshed of the base-station, and a list of such locations can be produced using the methodologies explained above in connection with the description of the customer qualification process (e.g., see third mode of customer qualification method producing all customers that can be served by a specific base-station).

A convenient way to represent a viewshed of a base-station is as a vector with elements corresponding to all customer locations in the target area. An element of the viewshed vector of a base-station is 1 if the corresponding location can be served. Otherwise, the element is 0. According to an embodiment, the viewshed vector need not have only elements of 0 and 1. The elements of the viewshed vector can be weighting factors of the customer locations. One example is for such a weight to represent the expected number of customers (or expected amount of revenue) from the customer location. If the location is outside the viewshed, the weight shall be zero. If the location is in the viewshed and there is one customer that has expressed interest in the service, the weight may be 0.8 (i.e. 80% probability). If the location is in the viewshed and there is one customer with no expressed interest, the weight may be 0.4. If there were 2 potential customers at that location, the weight would change to 2×0.4=0.8, and so on.

An equivalent yet condensed representation of the viewshed vector of a base-station is as a list of parcel identifiers (or similarly unique identifiers) corresponding to customer locations within the viewshed.

A few examples to illustrate the concept of a viewshed vector for a simple case of 8 customer locations are provided below. The viewshed vector of an example base-station can be:

[1 0 1 1 0 0 0 0]

Each element of this vector indicates if a customer location can be served or not. In this example, locations 1, 3 and 4 can be served, but locations 2, 5, 6, 7, and 8 cannot be served. The equivalent list representation is [1 3 4]. A weighted viewshed vector (e.g. taking into account customer sign-ups, or customers living in a duplex) can be:

[0.4 0 1.6 0.8 0 0 0 0]

In this case, there is one customer in location 1 who has not expressed interest in the service; there are two customers in location 3 who have expressed interest; and one customer in location 4 who has expressed interest. The equivalent list representation is [1 3 4] as before, but a separate table is needed to store the weights of each customer location.

The viewshed vector can be defined to take into account or to ignore the effect of existing base-stations. If existing base-stations are already serving customers 1 and 4, the above viewshed vector becomes:

[0 0 1 0 0 0 0 0] (or equivalently [3])

There are many possible positions in a candidate parcel for installing a base-station antenna. This raises the question of how to select the position within the parcel for computing the viewshed vector representing the candidate location of the base-station. There are many ways to choose the base-station position:
Select the median point of the parcel
Select the median point of the roof area within the parcel
Select the highest point of the roof area within the parcel
Select a preferable point (e.g. chimney) on the roof area within the parcel
Evaluate the viewshed vector for multiple points of the roof area within the parcel and select the point that maximizes a metric derived from the viewshed vector (an example method of selecting points of or within the parcel is from a grid; an example metric derived from the viewshed vector is a sum of the vector elements).

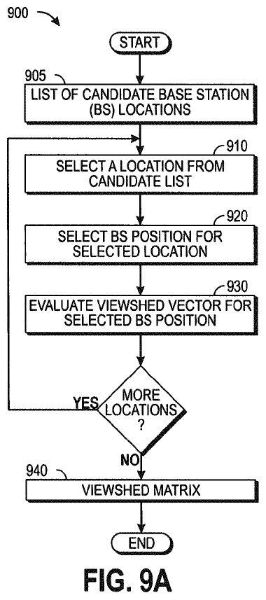

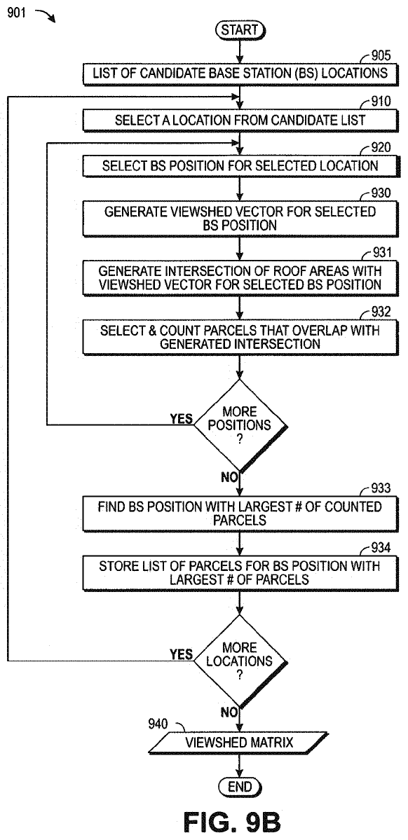

The steps for evaluating candidate base-station locations, according to an embodiment 900 of the invention, are as follows, with reference to FIG. 9A:
1. Given a list of candidate base station locations input at 905, select a location from the list of candidate base station locations at step 910;
2. Select a base-station position for the location selected in step 920;
3. Evaluate at step 930 a viewshed vector for the base-station position selected in step 920; and
4. If more candidate locations to evaluate, go to step 910, otherwise output a viewshed matrix at step 940, and end.

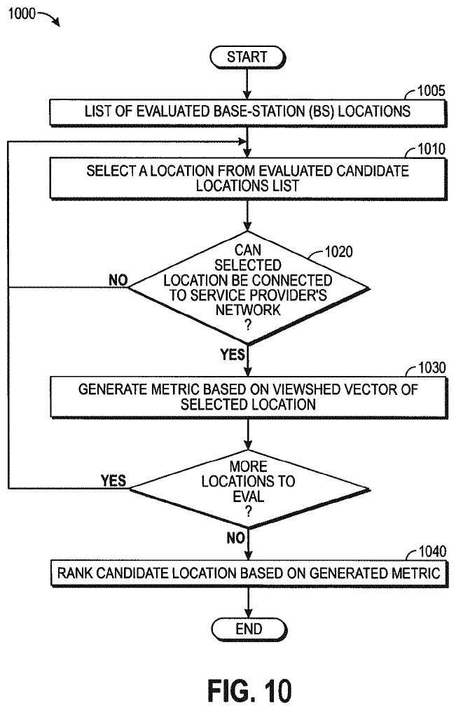

Regarding step 920, the selection of a location involves a sequential search thru the entire list of candidate locations. In one embodiment, the process at 920 involves iterating over each and every parcel of land (i.e., candidate base-station “locations”) to choose or find the best position for putting an antenna at that (i.e., inside or within the) location, for example, where exactly on the roof should one assume that the base-station antenna will be placed. When parcel data from a certain area are used for building the list of candidate locations, techniques can be applied to limit the size of the list. One such technique is to exclude from the list those parcels that do not contain buildings (e.g., whose land-use field is “park”) or those parcels that contain buildings below a certain height. Another technique would be to exclude those parcels whose owners have previously indicated they are not interested in having a base-station on their property (this field could time out or age such that a parcel is not excluded if the indication of non-interest is greater than a certain period of time, say, one year). According to one embodiment, the list of candidate locations may be limited to only those that are most favorable to being selected as new base-stations, for example, based on user input or other configurable input. According to another embodiment, with reference to FIG. 10, steps 1005 and 1010 (described below), the list of candidate locations can also be limited based on an evaluation of their viewshed vector. If the number of potential customer locations or the expected number of customers (derived by the viewshed vector) falls below a defined vector, the candidate location is eliminated. In another embodiment, e.g., to minimize iterations, e.g., after evaluating multiple locations and obtaining significant/satisfactory base-station coverage for geographic region, a decision may be made to not process further/remaining candidate locations.

Similar filtering techniques can be applied for parcels corresponding to customer locations. Parcels corresponding to non-occupied plots of land (e.g. empty space) can be excluded. Parcels corresponding to currently served customers may also be excluded. (An alternative approach to entirely excluding current customers is to assign a very small weight to them.) It is evident from the above description that the set of parcels used for the list of candidate locations for base-stations may partially overlap but may not match the set of parcels corresponding to the customer locations.

The output of this evaluation process can be represented as a viewshed matrix 940 consisting of rows corresponding to candidate base-station locations and columns corresponding to potential customer locations. Each row of the viewshed matrix is equal to the viewshed vector of the corresponding relay site/base-station location. An example viewshed matrix with 4 base-station locations (A, B, C and D), 8 customer locations, and with only weights of 0 (cannot serve) and 1 (can serve) is shown below:

| | 1 | 2 | 3 | 4 | 5 | 6 | 7 | 8 |
|---|---|---|---|---|---|---|---|---|
| A | 1 | 0 | 1 | 1 | 0 | 0 | 0 | 0 |
| B | 0 | 1 | 1 | 1 | 0 | 0 | 1 | 0 |
| C | 1 | 0 | 0 | 1 | 1 | 1 | 0 | 0 |
| D | 1 | 1 | 1 | 0 | 0 | 0 | 0 | 0 |

An alternative to the viewshed matrix is a list representation as shown below:

| | |
|---|---|
| A | [1 3 4] |
| B | [2 3 4 7] |
| C | [1 4 5 6] |
| D | [1 2 3] |

In one embodiment 901, with reference to FIG. 9B, the steps for evaluating candidate base-station locations are as follows:
1. Select a location at step 910 from list of candidate locations 905;
2. Select at step 920 a base-station position on a roof of the location selected in step 910;
3. Generate at step 930 a viewshed map for the base-station position selected in step 920;
4. Produce at step 931 an intersection of roof areas obtained from a roof identification map with the viewshed map generated in step 930, essentially generating a “roof limited” viewshed;
5. Select at step 932 parcels that have overlap with the intersection produced in step 931 and count the selected parcels;
6. Return to step 920 if more base-station positions on the roof of the selected location to evaluate; if not, go on to next step;
7. Find at step 933, for the selected location, the base-station position with the largest number of parcels counted in step 932;
8. Store, at step 934, the list of parcels corresponding to viewshed of the base-station position found to have the largest number of parcels in step 932; and
9. Return to step 910 if more candidate locations to consider, otherwise, output a viewshed matrix 940, and end.

These above described techniques use the following types of input data:
mapping data, characterizing the three-dimensional geography of the analyzed area;
candidate site locations, obtained either through owners registering and/or based on viewshed ranking;
weighted customer locations, obtained from sources such as parcel data, existing customer data, and the list of signed-up customers not served yet;
existing site locations, which can include both existing base-station locations, and locations with wired connectivity; and
minimum required connectivity, defined as the number of existing sites to which any new site should be able to connect.

Several techniques for ranking candidate base station locations are described below.

The evaluation of candidate locations for installing new base-stations produces a viewshed matrix 1040 (or an equivalent representation). The viewshed matrix is next used to rank the candidate locations.

In one embodiment, the objective of the ranking is to find one location to expand the existing network by one base-station. In other embodiments, the objective is to identify multiple locations to expand the existing network by a specific number of base-stations. The processes for both embodiments are described below.

An important constraint for ranking candidate locations for base-stations is the ability of each location to connect to the service provider's network (backhaul). A good way to take this constraint into account is to exclude from such ranking those locations that have no viable backhaul solution.

When the objective is to expand the existing network by one base-station, the fundamental steps of ranking the evaluated candidate base-station locations, according to an embodiment 1000, are as follows, with reference to FIG. 10:
1. Given a list of evaluated candidate base-station locations input at 1005, select a location from list of evaluated candidate base-station locations at 1010;
2. Check at step 1020 if the location selected in step 1010 can be connected to the service provider's network. If Yes, go to step 1030; if No, go to step 1010;
3. Produce at step 1030 a metric based on the viewshed vector of the location selected in step 1020;
4. If there are more candidate locations to evaluate, go to step 1010, otherwise, go on to the next step 1040;
5. Rank at step 1040 the candidate location based on the metric produced in step 1030, and end.

The connectivity check of step 1020 is explained further below.

One metric based on the viewshed vector that is used in one embodiment is the sum of the elements of the viewshed vector. If these elements are a binary representation of whether the corresponding customer can be served or not, then the metric equals the number of customer locations that are visible by the base-station at the candidate location. If these elements are the expected number of customers at this location, then the metric equals the aggregate expected number of customers that can be served at all locations visible by the base-station.

When the objective is to expand the existing network by a specific number of base-stations, then the ranking applies to a set of candidate base-station locations, and the metric is based on a combined viewshed vector of these base-stations. This is next explained with an example.

A viewshed matrix with 4 relay sites/base-station candidate locations and 8 customer locations is as shown below:

| | 1 | 2 | 3 | 4 | 5 | 6 | 7 | 8 |
|---|---|---|---|---|---|---|---|---|
| A | 1 | 0 | 1 | 1 | 0 | 0 | 0 | 0 |
| B | 0 | 1 | 1 | 1 | 0 | 0 | 1 | 0 |
| C | 1 | 0 | 0 | 1 | 1 | 1 | 0 | 0 |
| D | 1 | 1 | 1 | 0 | 0 | 0 | 0 | 0 |

This matrix shows, for example, that location 1 can be served by any of relays A, C or D; location 7 can only be served by relay B; and location 8 cannot be served by any relay.

Consider the case, where the goal of network expansion is to select two new base-stations (among the possible base stations A, B, C and D in the above matrix) to install or add to the existing fixed-wireless communication network. The viewshed matrix can be used to derive the combined viewshed matrix of multiple base-stations. One method to obtain this combined viewshed is by applying a Boolean OR operation element-wise to the corresponding viewshed vectors. For n relay sites (possible base-station locations) and selecting k relay sites among those n relay sites for combining, the combined viewshed matrix has “n choose k” rows, according to the mathematical operation for computing a Binomial coefficient. Continuing the previous example, when combining 2 base-stations at a time, the combined viewshed matrix is as follows:

| | 1 | 2 | 3 | 4 | 5 | 6 | 7 | 8 |
|---|---|---|---|---|---|---|---|---|
| A + B | 1 | 1 | 1 | 1 | 0 | 0 | 1 | 0 |
| A + C | 1 | 0 | 1 | 1 | 1 | 1 | 0 | 0 |
| A + D | 1 | 1 | 1 | 1 | 0 | 0 | 0 | 0 |
| B + C | 1 | 1 | 1 | 1 | 1 | 1 | 1 | 0 |
| B + D | 1 | 1 | 1 | 1 | 0 | 0 | 1 | 0 |
| C + D | 1 | 1 | 1 | 1 | 1 | 1 | 0 | 0 |

This example shows that there are 6 groups each consisting of two candidate base-stations that need to be ranked. Each of the 6 groups has a combined viewshed vector on which a metric can be computed for the purpose of ranking the 6 groups.

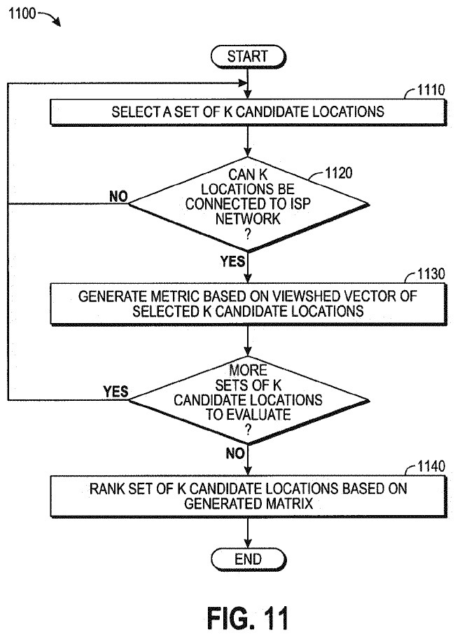

For an embodiment 1100 that expands the existing network by k of n base-stations, the fundamental steps of ranking the evaluated sets of candidate locations are as follows, with reference to FIG. 11:
1. Select set of k candidate locations at step 1110;
2. Check at step 1120 if the k locations selected in step 1110 can be connected to the service provider's network; if Yes, go to step 1130; if No, go to step 1110;
3. Generate at step 1130 a metric based on the viewshed vector of the k candidate locations selected in step 1120;
4. If there are more sets of k candidate locations to evaluate, go to step 1110; if not, go to step 1140; and
5. Rank at step 1140 the sets of k candidate locations based on the metric produced in step 1130, and end.

Metrics based on the viewshed vector of one candidate location can also be used as metrics for the viewshed vector of a set of multiple candidate locations.

When having to rank sets of candidate locations, one complication is that the number of sets to rank can increase very rapidly. The table that follows illustrates this problem with a few examples:

| | | | Total number of |
|---|---|---|---|
| | All candidate | New base- | combinations to |
| | locations (n) | stations (k) | rank (n choose k) |
| Example 1 | 200 | 5 | 2.535e9 |
| Example 2 | 100 | 5 | 75.288e6 |
| Example 3 | 200 | 3 | 1.313e6 |
| Example 4 | 102 | 3 | 171,700 |
| Example 5 | 100 | 2 | 4,950 |
| Example 6 | 60 | 2 | 1,770 |

For this reason, according to one embodiment, there is an additional step to limit the number of candidate locations to only those that are most favorable to being selected as new base-stations. For example, candidate locations can be excluded if they do not meet a minimum roof height requirement, or if a backhaul connection to the rest of the network is not feasible.

Candidate locations can also be limited based on an evaluation of their viewshed vector. If the number of potential customer locations or the expected number of customers (derived by the viewshed vector) falls below a defined vector, the candidate location is eliminated.

According to an embodiment, the objective is to select the “next-best” location for installing a single base-station, in which case, the algorithm produces a ranked list of site locations. The ranking can be based on a metric such as the incremental coverage achieved by the location (i.e., the number of new, as yet unserved, parcels that can be served by a base-station installed at the location). An example of such a ranked list is shown below:

| | Incremental coverage |
|---|---|
| Location | (# of parcels) |
| 44323 Conifer St | 235 |
| 83211 Hackberry St | 153 |
| 66123 Purpleleaf St | 78 |
| 34792 Cottonwood St | 54 |

According to another embodiment, the objective is to select multiple locations for installing a network of base-stations, in which case, the algorithm produces a ranked list of multiple site locations, where a ranking can similarly be based on a metric such as incremental coverage achieved by these locations. An example of a ranked list of groups of two locations is shown below:

| | Incremental coverage |
|---|---|
| Locations | (# of parcels) |
| 44323 Conifer St, 66123 | 327 |
| Purpleleaf St | |
| 44323 Conifer St, 34792 | 271 |
| Cottonwood St | |
| 44323 Conifer St, 83211 | 268 |
| Hackberry St | |
| 83211 Hackberry St, 34792 | 201 |
| Cottonwood St | |

In the latter case, individual locations may be further ranked according to the number of times that they appear in the list of groups of locations. Continuing the previous example, “44323 Conifer St” would be ranked first (appearing in 3 groups), “34792 Cottonwood St” and “83211 Hackberry St” would be tied for second and third (each appearing in 2 groups), and “66123 Purpleleaf St” would be ranked fourth (appearing in only one group). Such scoring may also be combined with metrics such as incremental coverage.

The analysis described above and the associated ranking and metrics it generates can be used for determining the suitability of a site for base-station installation. Other metrics may alternately be used, for example, for producing a weighted number of parcels to account for multi-dwelling units or office buildings, or to weigh more heavily potential higher-revenue business customers. The analysis may be produced periodically with results stored in appropriate electronic storage media, or it may be produced on-demand whenever there is a need to evaluate a given site.

Additional techniques for generating a metric characterizing the site location are described below.

Checking for Connectivity

As described earlier, filtering can be applied to candidate locations or to sets of candidate locations to eliminate those that cannot be connected to the service provider's network. Each candidate location (or each set of candidate locations) can be assigned a connectivity metric. If this connectivity metric falls below a defined threshold, then the candidate location (or the set of candidate locations) is excluded from further consideration.

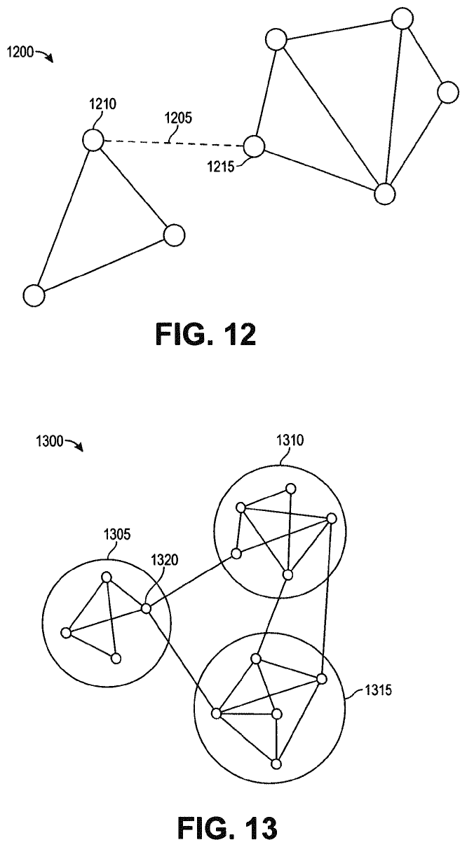

At its simplest, according to an embodiment, the connectivity metric can equal 1 when connectivity is possible, and 0 when connectivity is not possible. More complex connectivity metrics suitable for this application can be derived using the concepts of vertex-connectivity and edge-connectivity from graph theory. Base-stations are to be represented as vertices of a graph. An edge between two vertices is drawn if the corresponding base-stations can be connected. In the (most common) case of wireless backhaul, that is determined by the existence of an LOS path between the two locations. (The concept of a viewshed matrix can also be applied to evaluate such backhaul connectivity.) An example graph 1200 is shown in FIG. 12.

In this example graph illustrated in FIG. 12, we see a single dashed edge 1205 connecting two vertices 1210 and 1215. If this edge is removed, the graph becomes disconnected. For a base-station network corresponding to this graph, this means that the corresponding link failure would make the two parts of the network unable to communicate with each other.

Edge-connectivity between two vertices of a graph is the size of the smallest edge cut disconnecting the two vertices. Edge-connectivity of the graph is the size of the smallest edge cut that renders the graph disconnected. For the previous example, the edge-connectivity of the graph is 1.

FIG. 13 illustrates a second example to illustrate vertex-connectivity. The graph 1300 in FIG. 13 becomes disconnected when node 1320 in the area 1305 defining a first sub-network is removed. For the corresponding relay network, this means that a power or other failure at the corresponding relay site would make the first sub-network in the area 1320 unable to communicate with the second and third sub-networks defined by the respective areas 1310 and 1315.

Vertex-connectivity between two vertices of a graph is the size of the smallest vertex cut disconnecting the two vertices. Vertex-connectivity of a graph is the size of the smallest vertex cut making the graph disconnected. For the previous example, the vertex-connectivity of the graph is 1.

When applied to base-stations in a wireless network, the edge-connectivity between a candidate base-station and an existing relay node corresponds to the minimum number of backhaul link failures that would cause the candidate base-station to become unreachable. The vertex-connectivity between a candidate base-station and an existing relay node corresponds to the minimum number of node failures that would cause the candidate base-station to become unreachable. The minimum of vertex-connectivity over all candidate base-stations in a set is a very good measure of resiliency for this candidate set. The minimum of edge-connectivity over all candidate base-stations in a set is a second resiliency measure that can be used.

Computing vertex-connectivity and edge-connectivity on graphs are well-studied problems. Both problems can be solved using the principles of the max-flow-min-cut-set theorem, and using algorithms such as Ford-Fulkerson.

Generate Decision for Site Location 415

Given an identified site location (e.g., via a site owner registering on a website), and given a generated analysis for that site location (e.g., in the form of a metric quantifying the site's desirability for installing a base-station), the next step is the generation of a decision for the site location. The decision is mainly about the next step of the service provider.

If the location's metric meets a specified threshold for suitability, then the decision can be to proceed with the base-station's installation. This may require further exchanges with the site owner until the signing of an agreement is accomplished. It may also require further technical evaluation and analysis to produce a detailed installation plan. If the location's metric falls below a specific threshold for suitability, then the decision can be to dismiss the base-station's installation. There may be an intermediate situation, where the location's metric indicates that the location is not (currently) an ideal choice for a base-station installation, but that its suitability may increase in the future (e.g., after adding other base-stations, or after adding a substantial number of customers in the area, or after some change in the location's environment (e.g., removal of trees, addition of a structure or building, etc.). In that intermediate situation, the decision may be to postpone installation, but to record the findings and to plan for a future review.

Each of the decision outcomes requires providing a response to the site owner who has expressed interest in having a base-station installed at the site. In one embodiment, the response is provided via the website where the owner registers.

In the case of a positive decision for installing a base-station, the site owner can be offered a contract. Although most terms and conditions of the contract should be standardized, the amount of any monetary compensation can be computed based on the location's metric (or metrics). A highly suitable location may include substantial payments from the service provider to the site owner. A less suitable location may include no such payments, or may even include payments from the site owner to the service provider. Alternatively, the contract may specify that payments will be made in the future using a formula that estimates the benefit of the installed base-station to the service provider. This formula can include variables such as:
number of directly served customers;
number of directly served potential customers;
number of customers served by existing sites that connect via this location;
number of potential customers served by existing sites that connect via this location; and
number of potential customers served by planned sites that will connect via this location.

The formula may be a weighted sum or some other combination of the above variables. In any such formula, it would be typical for a number of potential customers to weigh less heavily than a number of current customers. It would also be possible to replace customer counts with amounts of expected revenue.

In the case of the decision to defer installing a base-station at the site, the site owner may still be offered a contract. Such a contract may include the future option for the service provider to install a base-station, and may be accompanied by appropriate monetary or other compensation.

Embodiments involving the above described general steps are discussed below.

### First Embodiment

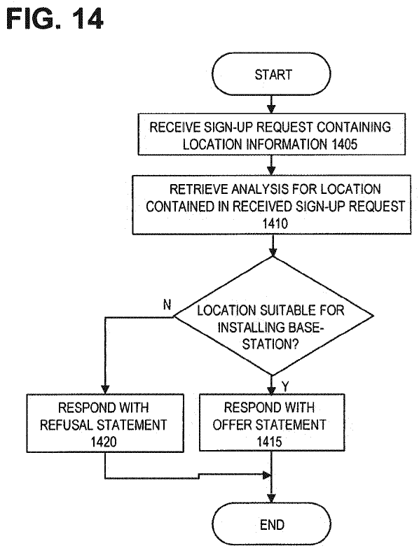

One embodiment for network design and site acquisition involves the following steps, with reference to FIG. 14:
receive sign-up request containing location information at step 1405;
retrieve analysis for location contained in the received sign-up request at step 1410;
if analysis indicates suitability for installing a base-station at the location, respond to sign-up request with offer statement at step 1415; and
if analysis indicates lack of suitability for installing a base-station at the location, respond to sign-up request with refusal statement at step 1420.

### Second Embodiment

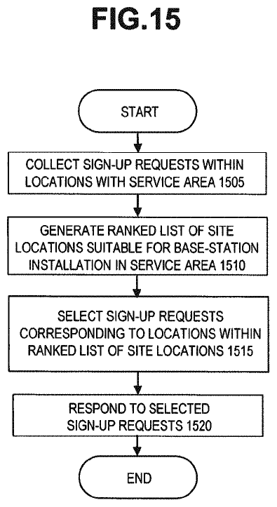

Another embodiment for network design and site acquisition involves the following steps, with reference to FIG. 15:
collect sign-up requests with locations within a service area at step 1505; generate a ranked list of site locations suitable for base-station installation in the service area at step 1510;
select sign-up requests corresponding to locations within the ranked list of site locations at step 1515; and
respond to the selected sign-up requests at step 1520.

### Third Embodiment

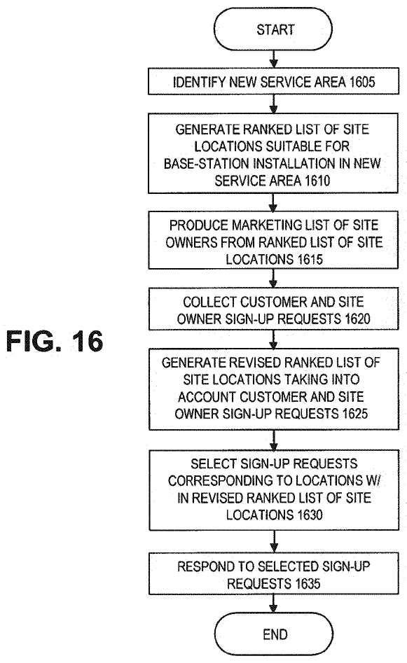

A more detailed embodiment for network design and site acquisition involves the following steps, with reference to FIG. 16:
identify a new service area at step 1605;
generate a ranked list of site locations suitable for base-station installation in the new service area at step 1610;
produce a marketing list of site owners from the ranked list of site locations at step 1615;
collect customer and site owner sign-up requests at step 1620;
generate revised ranked list of site locations taking into account the customer and site owner sign-up requests at step 1625;
select sign-up requests corresponding to locations within the revised ranked list of site locations at step 1630; and
respond to the selected sign-up requests at step 1635.

### Fourth Embodiment

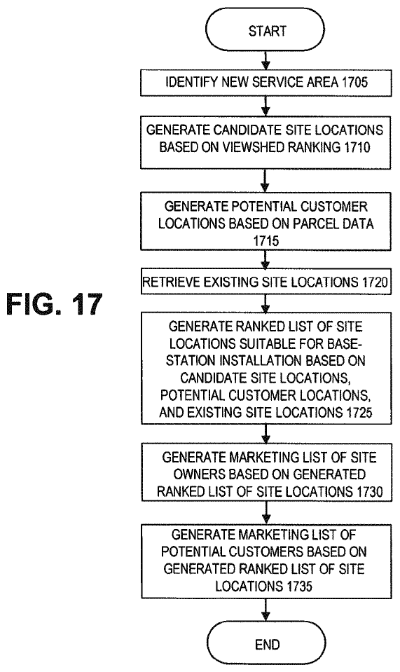

Another more detailed embodiment for network design and site acquisition involves the following steps, in a “greenfield” scenario, with reference to FIG. 17:
identify new service area at step 1705;
generate candidate site locations based on viewshed ranking at step 1710;
generate potential customer locations based on parcel data at step 1715;
retrieve existing site locations at step 1720;
generate ranked list of site locations suitable for base-station installation based on candidate site locations, potential customer locations and existing site locations at step 1725;
generate a marketing list of site owners based on the generated ranked list of site locations at step 1730; and
generate a marketing list of potential customers based on the generated ranked list of site locations at step 1735.

### Fifth Embodiment

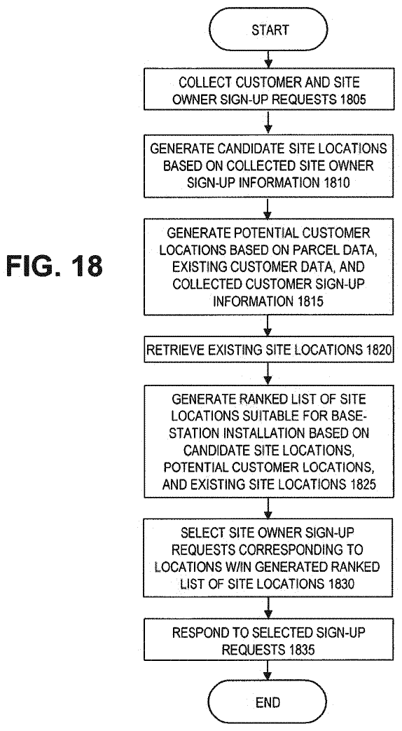

Yet another more detailed embodiment for network design and site acquisition involves the following steps in a “densification” scenario, with reference to FIG. 18:
collect customer and site owner sign-up requests at step 1805;
generate candidate site locations based on the collected site owner sign-up information at step 1810;
generate potential customer locations based on parcel data, existing customer data, and the collected customer sign-up information at step 1815;
retrieve existing site locations at step 1820;
generate ranked list of site locations suitable for base-station installation based on candidate site locations, potential customer locations and existing site locations at step 1825;
select site owner sign-up requests corresponding to locations within the generated ranked list of site locations at step 1830; and
respond to the selected sign-up requests at step 1835.

### Blockchain-Based Network Design and Site Acquisition

Blockchain technology can be used to facilitate the network design and site acquisition processes described above. Fundamental aspects of such an approach are described below. A base-station site of a wireless network may transition through the following stages or states:
site identified as candidate for base-station installation (“Identified”);
site approved for base-station installation (“Approved”);
base-station installation is in progress (“Installation”);
site is operational (“Operational”); and
site is retired (“Retired”).

These are typical states, but they do not need to be the only states. Transition from one state to the next requires at least one transaction between at least two parties. For example, transition from “Identified” to “Approved” can require that the service provider and the site owner have signed a contract. In some cases, it may further require that a regulating authority has provided all necessary permits for the site. Transition from “Approved” to “Installation” may require the site owner giving access rights to the service provider. Transition from “Installation” to “Operational” may trigger a revenue-sharing schedule according to which the service provider is making payments to the site owner. Transition from “Operational” to “Retired” should include a transaction for terminating the contract between the service provider and the site owner.

Transactions can take place among parties such as:
service provider (or in some cases multiple service providers);
site owners;
regulating authority (or in some cases multiple regulating authorities);
base-station installation providers; and
investors.

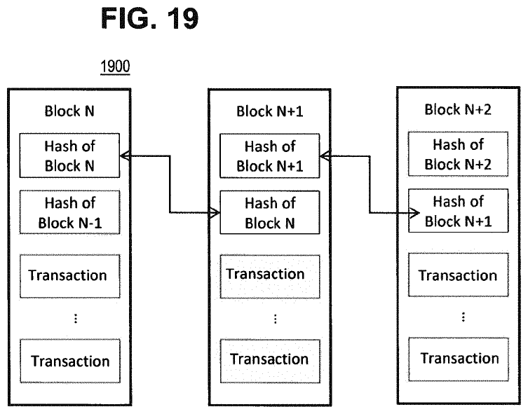

Transactions may be in the custody of a trusted arbiter, which would typically be a service provider. Alternatively, transactions can be stored in a blockchain. In a standard blockchain implementation, each block consists of a hash, batches of valid transactions, and the hash of the previous block. Such linking of blocks via hashes protects against tampering of the transaction record stored in the blockchain. See example of a blockchain 1900 in FIG. 19.

The transaction record in a blockchain is in effect a shared ledger. Each party (or “network participant” or “node” in blockchain terminology) has a duplicate copy of the blockchain. Also, each party has permission to view details of only those transactions for which it is authorized. For example, the contract details in a transaction between a service provider and one site owner may be hidden from other site owners. For this purpose, stored transactions may be cryptographically signed.

Adding transactions to the blockchain requires a mechanism to prevent different parties from disagreeing on the state of the blockchain. One method for adding transactions is having a permissioned blockchain, where certain trusted entities must form consensus before a new block is added. In one embodiment, trustees include the service provider and a select subset of participants meeting certain trust criteria (e.g., site owners with long tenure, or large investors).

A second method for adding transactions is to use consensus mechanisms such as “proof of stake” or “multi-signature”. In a “proof of stake” example, the transactions must be validated by a number of site owners exceeding a minimum percentage of the network. In a “multi-signature” example, a majority of site owners or a majority of investors must validate the transactions.

Smart contracts can be stored in the blockchain to contain sets of rules for each transaction. For example, there may be smart contracts to govern payments from the service provider to a site owner. There may be smart contracts to establish rules and payments associated with the work performed by base-station installers. There may be smart contracts to govern payments made to an investor, who has acquired a stake in the revenue stream of a site.

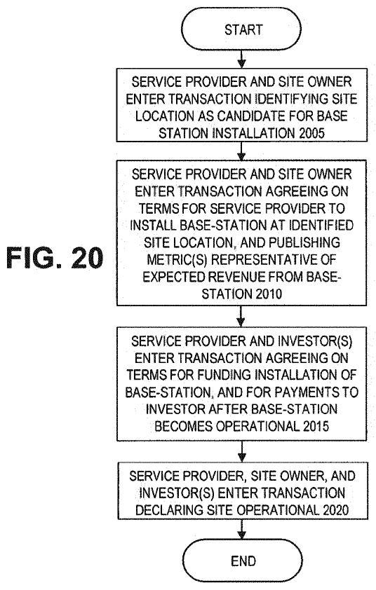

The steps according to an embodiment for blockchain-based network design and site acquisition follows, with reference to FIG. 20:
a service provider and a site owner enter a transaction identifying a site location as a candidate for base-station installation at step 2005;
the service provider and the site owner enter a transaction agreeing on terms for the service provider to install a base-station at the identified site location, and publishing one or more metrics representative of expected revenue from the base-station at step 2010;
the service provider and at least one investor enter a transaction agreeing on terms for funding the installation of the base-station and for payments to the investor after the base-station becomes operational at step 2015; and
the service provider, the site owner and the at least one investor enter a transaction declaring the site as operational at step 2020.

Thus, the steps according to the embodiment describe with respect to FIG. 20 generally involves a method of distributed management of a wireless network, comprising recording of a transaction between at least two parties, where the transaction characterizes the state of a site. In one embodiment, the parties comprise one or more of the following:
a service provider;
a site owner;
an investor;
a regulating authority; and
a base-station installation provider.

According to one embodiment of the method, the transaction comprises one or more of the following:
a transaction between a service provider and a site owner giving rights to the service provider for installing a base-station at the site;
a transaction between an investor and a service provider defining an investment in the site; and
a transaction between a service provider and a regulating authority providing a permit to the service provider for installing a base-station at the site.

According to one embodiment of the method, the state of the site comprises one or more of:
the site being identified as a candidate for base-station installation;
the site being approved for base-station installation;
the site waiting for at least one investor to fund the installation of a base-station;
a base-station installation being in progress at the site;
the site being operational; and
the site being retired.

According to one embodiment of the method, the recording of the transaction comprises recording the transaction in a blockchain. The blockchain contains smart contracts specifying the rules for transactions, according to an embodiment.

To summarize further, according to one embodiment, the method of distributed management of a wireless network comprises a service provider and a site owner entering a transaction identifying a site location as a candidate for base-station installation. The service provider and the site owner enter a transaction agreeing on terms for the service provider to install a base-station at the identified site location, and publish one or more metrics representative of expected revenue from the base-station. The service provider and at least one investor entering a transaction agree on terms for funding the installation of the base-station and for payments to the investor after the base-station becomes operational. The service provider, the site owner and the at least one investor enter a transaction declaring the site as operational.

Wireless Network Design with Self-Interference

In conditions of limited spectrum availability, it is essential to design a cellular system with the further restriction that multiple base-stations corresponding to cells within a service area must use the same frequency or must choose from a small set of frequencies. In such a situation, there is significant potential for inter-cell interference.

Techniques like the Spectrum Reuse Synchronization (SRS) protocol used by Mimosa radio products operating in the 5 GHz band, available from Airspan Networks Inc., reduce the potential for inter-cell interference, but do not completely eliminate it. Specifically, a TDMA protocol synchronized across all base-stations can eliminate interference from a transmitting base-station in one cell to a receiving base-station in a neighboring cell, and also interference from a transmitting client radio in one cell to a receiving client radio in a neighboring cell. That still leaves the possibility of a transmitting base-station causing interference to a receiving client radio in a neighboring cell, or of a transmitting client radio causing interference to a receiving base-station in a neighboring cell. In fixed wireless applications, this possibility is further mitigated by the fact that client radios use directional antennas, hence this self-interference effect has a serious impact under the following conditions:
the angle formed between the line from the client radio to the base-station serving it and the line from the client radio to a base-station of a neighboring cell is smaller than the antenna beam-width; and
the base-station of the neighboring cell uses a frequency channel that overlaps (at least partially) with the frequency channel of the base-station serving the client radio.

The self-interference effect is prominent in areas where base-station viewsheds are not impeded by vegetation, structures or terrain. When base-stations are installed at high elevation locations or in areas with clear and open terrain, then cell areas may have significant overlap, because there are no natural obstacles to limit radio-wave propagation. In a hypothetical example of a flat geography with no vegetation or structures, any client radio is able to connect to any base-station within a certain range. A suburban neighborhood of two-story single-family homes, with flat terrain, with young or small trees, and where base-stations and client radios are mounted on rooftops, fits this description.

Cell-based wireless network design methods, such as those described in International application no. PCT/US2019/039617, filed Jun. 27, 2019, entitled “Method and Apparatus for Qualifying Customers and Designing a Fixed Wireless Network using Mapping Data”, can be modified to mitigate self-interference effects by not allowing designs that lead to a high potential for self-interference.

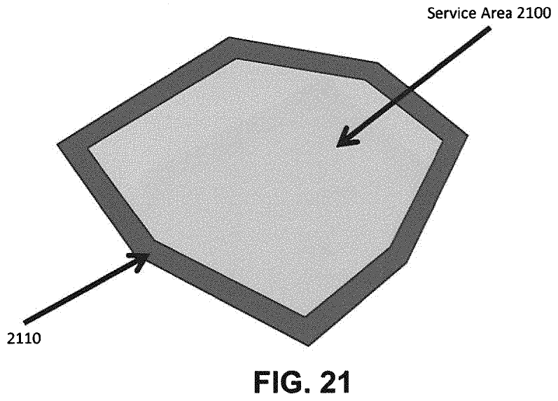

In a first embodiment, the relay site selection algorithm is modified to only select relay sites in the periphery of, or on a ring around, the target service area. With reference to FIG. 21, the perimeter of the service area 2100 is defined by the outer edge of polygon 2110. If the area for selecting relay sites is limited to the zone defined by the inner and outer edges of polygon 2110, in the periphery of the service area 2100, then self-interference is significantly limited. Ideally, zone 2110 includes homes, buildings and structures in the property parcels exactly on the perimeter of service area 2100. More practically, zone 2110 may include homes, building and structures in the property parcels near the perimeter of service area 2100. For example, property parcels may be chosen within a certain distance of the perimeter of service area 2100, where such distance may correspond to 3 times the average diameter of a parcel, in one example embodiment.

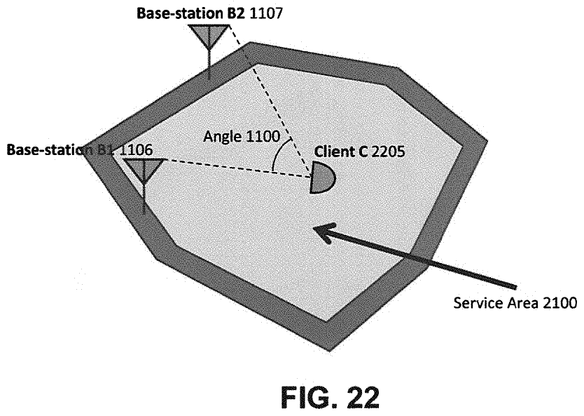

FIG. 22 demonstrates the effect more clearly. A client radio C 2205 within the service area 2100 points to the base-station B1 2206 serving it. If base-station B1 and base-station B2 2207 are sufficiently spaced apart, then the angle 2200 formed between the line from the client radio C to the base-station B1 serving it and the line from the client radio C to the base-station B2 of a neighboring cell is larger than the antenna beam-width. Therefore, self-interference is prevented.

The above strategy significantly limits self-interference, but does not completely eliminate the chance that it arises. There may still be cases of client radios at or near the periphery of the target service area, which may be oriented such that the client radio is aligned with two base-stations.

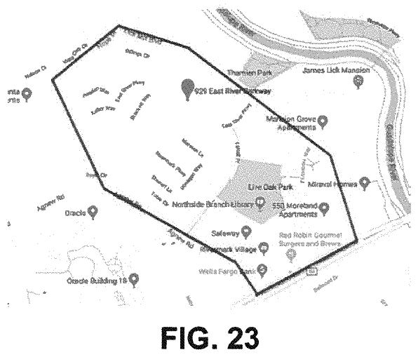

In a second embodiment, the relay site selection algorithm is modified to select relay sites at or near the corners of the polygon defining the target service area. In one embodiment, corners may be defined by physical features of the target service area, such as road intersections, as illustrated in FIG. 23. This restriction further diminishes the probability of a client radio being in a location, where the angle formed between the line from the client radio to the base-station serving it and the line from the client radio to a base-station of a neighboring cell is larger than the antenna beam-width, thereby preventing self-interference.

Thus, according to the embodiments described above with respect to FIGS. 21-23, a method for designing a wireless network involves identifying a site location in a periphery or on a ring around a target service area as a candidate for a base-station installation, generating an analysis of the identified site location characterizing suitability for the base-station installation, and generating a decision to install a base-station at the identified site location based on the generated analysis.

Further, according to the embodiments described above with respect to FIGS. 21-23, a method for designing a wireless network involves identifying a site location at or near one or more corners of a polygon defining a target service area as a candidate for a base-station installation, generating an analysis of the identified site location characterizing suitability for the base-station installation, and generating a decision to install a base-station at the identified site location based on the generated analysis.

### Computing Environment

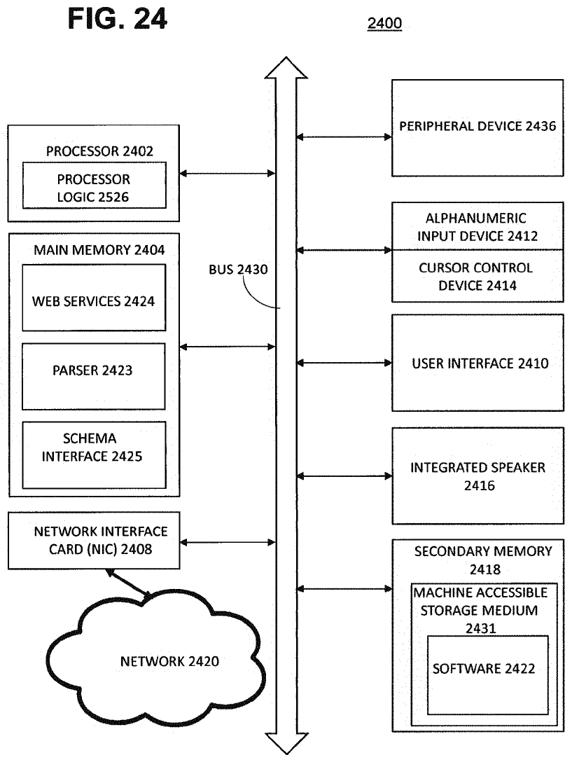

FIG. 24 illustrates a diagrammatic representation of a machine 2400 in the exemplary form of a computer system, in accordance with one embodiment, within which a set of instructions, for causing the machine 2400 to perform any one or more of the methodologies discussed herein, may be executed. In alternative embodiments, the machine may be connected, networked, interfaced, etc., with other machines in a Local Area Network (LAN), a Wide Area Network, an intranet, an extranet, or the Internet. The machine may operate in the capacity of a server or a client machine in a client-server network environment, or as a peer machine in a peer to peer (or distributed) network environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 2400 includes a processor 2402, a main memory 2404 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), etc.), and a secondary memory 2418, which communicate with each other via a bus 2430. Main memory 2404 includes information and instructions and software program components necessary for performing and executing the functions with respect to the various embodiments of the systems, methods for implementing embodiments of the invention described herein. Instructions 2423 may be stored within main memory 2404. Main memory 2404 and its sub-elements are operable in conjunction with processing logic 2426 and/or software 2422 and processor 2402 to perform the methodologies discussed herein.

Processor 2402 represents one or more general-purpose processing devices such as a microprocessor, central processing unit, or the like. More particularly, the processor 2402 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 2402 may also be one or more special-purpose processing devices such as an application specific integrated circuit (ASIC), a field programmable gate array (FPGA), a digital signal processor (DSP), network processor, or the like. Processor 2402 is configured to execute the processing logic 2426 for performing the operations and functionality which are discussed herein.

The computer system 2400 may further include one or more network interface cards 2408 to interface with the computer system 2400 with one or more networks 2420. The computer system 2400 also may include a user interface 2410 (such as a video display unit, a liquid crystal display (LCD), or a cathode ray tube (CRT)), an alphanumeric input device 2412 (e.g., a keyboard), a cursor control device 2414 (e.g., a mouse), and a signal generation device 2416 (e.g., an integrated speaker). The computer system 2400 may further include peripheral device 2436 (e.g., wireless or wired communication devices, memory devices, storage devices, audio processing devices, video processing devices, etc.).

The secondary memory 2418 may include a non-transitory machine-readable storage medium (or more specifically a non-transitory machine-accessible storage medium) 2431 on which is stored one or more sets of instructions (e.g., software 2422) embodying any one or more of the methodologies or functions described herein. Software 2422 may also reside, or alternatively reside within main memory 2404, and may further reside completely or at least partially within the processor 2402 during execution thereof by the computer system 2400, the main memory 2404 and the processor 2402 also constituting machine-readable storage media. The software 2422 may further be transmitted or received over a network 2420 via the network interface card 2408.

Some portions of this detailed description are presented in terms of algorithms and representations of operations on data within a computer memory. These algorithmic descriptions and representations are the means used by those skilled in the data processing arts to most effectively convey the substance of their work to others skilled in the art. An algorithm is here, and generally, conceived to be a sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from this discussion, it is appreciated that throughout the description, discussions utilizing terms such as “processing” or “computing” or “calculating” or “determining” or “displaying” or the like, refer to the action and processes of a computer system or computing platform, or similar electronic computing device(s), that manipulates and transforms data represented as physical (electronic) quantities within the computer system's registers and memories into other data similarly represented as physical quantities within the computer system memories or registers or other such information storage, transmission or display devices.

In addition to various hardware components depicted in the figures and described herein, embodiments further include various operations which are described below. The operations described in accordance with such embodiments may be performed by hardware components or may be embodied in machine-executable instructions, which may be used to cause a general-purpose or special-purpose processor programmed with the instructions to perform the operations. Alternatively, the operations may be performed by a combination of hardware and software, including software instructions that perform the operations described herein via memory and one or more processors of a computing platform.

Embodiments of invention also relate to apparatuses for performing the operations herein. Some apparatuses may be specially constructed for the required purposes, or may comprise a general purpose computer(s) selectively activated or configured by a computer program stored in the computer(s). Such a computer program may be stored in a computer readable storage medium, such as, but not limited to, any type of disk including optical disks, CD-ROMs, DVD-ROMs, and magnetic-optical disks, read-only memories (ROMs), random access memories (RAMs), EPROMs, EEPROMs, NVRAMs, magnetic or optical cards, or any type of media suitable for storing electronic instructions, and each coupled to a computer system bus.

The algorithms presented herein are not inherently related to any particular computer or other apparatus. Various general purpose systems may be used with programs in accordance with the teachings herein, or it may prove convenient to construct more specialized apparatus to perform the required methods. The structure for a variety of these systems appears from the description herein. In addition, embodiments of the invention are not described with reference to any particular programming language. It will be appreciated that a variety of programming languages may be used to implement the embodiments of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices, etc.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims that follow. Features of the disclosed embodiments can be combined and rearranged in various ways.

What is claimed is:

1. A method for designing a wireless network, comprising:
identifying a site location as a candidate for a base-station installation;
generating a viewshed for an antenna of the base-station at the identified site location;
computing an area of a rooftop of at least one customer location that is included in the generated viewshed;
indicating the at least one customer location as able to be served by the base-station based on the area of the rooftop of the at least one customer location that is included in the generated viewshed; and
generating a decision to install the base-station at the identified site location based on the indication.

2. The method of claim 1, wherein identifying the site location as the candidate for the base-station installation comprises an owner of the site location signing up to install the base-station.

3. The method of claim 2, wherein the site owner signing up comprises:
selecting a base-station position within each site location;
computing a viewshed vector representing the site location and all corresponding possible customer locations within the viewshed, based on the selected base-station position within each site location; and
generating a viewshed matrix comprising the respective computed viewshed vectors representing each site location;
ranking the site locations using the viewshed matrix;
identifying potential site owners based on a ranking of the viewshed of the site locations;
sending marketing information to the identified potential site owners;
receiving sign-up information from at least one of the identified potential site owners.

4. The method of claim 3, wherein ranking the site locations further comprises determining if each site location can be connected to a service provider's network.

5. The method of claim 4, wherein ranking the site locations further comprises calculating a metric based on the viewshed vector of the site location and ranking the site locations based the calculated metric.

6. The method of claim 1, wherein computing the area of the rooftop of the at least one customer location that is included in the generated viewshed comprises:
receiving rooftop area information for the at least one customer location;
generating a shape of an intersection of the viewshed and rooftop area for the at least one customer location;
computing an area for the shape; and
wherein indicating the at least one customer location as able to be served by the base-station based on the area of the rooftop at the at least one customer location that is included in the generated viewshed comprises indicating the at least one customer location as able to be served by the base-station based on the computed area for the shape.

7. The method of claim 1, further comprising generating an incremental coverage metric for the identified site location; and
wherein generating the decision to install the base-station at the identified site location further is based on the incremental coverage metric for the identified site location.

8. The method of claim 1, wherein generating the decision to install the base-station at the identified site location comprises at least one of:
generating a decision to proceed with the base-station's installation;
generating a decision to postpone the base-station's installation;

9. The method of claim 1, wherein generating the decision to install the base-station at the identified site location includes comparing a metric characterizing the site location with a defined threshold.

10. The method of claim 1, further comprising computing a formula for compensation offered to the site owner.

11. The method of claim 10, wherein the formula includes at least one of:
current customer count;
potential customer count;
current revenue; and
potential revenue.

12. The method of claim 1, further comprising:
receiving a sign-up request containing the identified site location;
retrieving the indication of the at least one customer location as able to be served by the base-station for the identified site location contained in the received sign-up request; and
responding to the sign-up request with an offer statement, responsive to the generation of the decision to install the base-station at the identified site location based on the indication.

13. The method of claim 1, further comprising:
collecting sign-up requests from respective site locations within a service area;
generating a ranked list of the respective site locations suitable for base-station installation in the service area responsive to the indication of the respective at least one customer location as able to be served by the base-station;
selecting sign-up requests corresponding to site locations within the ranked list of the respective site locations; and
responding to the selected sign-up requests, responsive to the generation of the decision to install the base-station at the identified site location based on the respective indication which corresponds to a site location within the ranked list of the respective site locations.

14. The method of claim 1, further comprising:
identifying a new service area;
generating a ranked list of site locations suitable for base-station installation in the new service area responsive to the respective indications;
producing a marketing list of site owners from the ranked list of site locations;
collecting customer and site owner sign-up requests;
generating a revised ranked list of site locations taking into account the customer and site owner sign-up requests;
selecting sign-up requests corresponding to site locations within the revised ranked list of site locations; and
responding to the selected sign-up requests.

15. The method of claim 1, further comprising:
identifying a new service area;
generating candidate site locations based on viewshed ranking;
generating potential customer locations based on parcel data;
retrieving existing site locations;
generating a ranked list of site locations suitable for base-station installation based on the generated candidate site locations, generated potential customer locations and retrieved existing site locations;
generating a marketing list of site owners based on the generated ranked list of site locations; and
generating a marketing list of potential customers based on the generated ranked list of site locations.

16. The method of claim 1, further comprising:
collecting customer and site owner sign-up requests;
wherein identifying a site location as a candidate location for a base-station installation comprises generating candidate site locations based on the collected site owner sign-up requests;
generating potential customer locations based on parcel data, existing customer data, and the collected customer sign-up requests;
retrieving existing site locations;
generating a ranked list of site locations suitable for base-station installation based on the generated candidate site locations, generated potential customer locations and retrieved existing site locations;
selecting site owner sign-up requests corresponding to site locations within the generated ranked list of site locations; and
responding to the selected sign-up requests.

17. Non-transitory computer readable storage media having instructions stored thereon that, when executed by a processor of a system, the instructions cause the system to perform operations for designing a wireless network, comprising:
identifying a site location as a candidate for a base-station installation;
generating a viewshed for an antenna of the base-station at the identified site location;
computing an area of a rooftop of at least one customer location that is included in the generated viewshed;
indicating the at least one customer location as able to be served by the base-station based on the area of the rooftop of the at least one customer location that is included in the generated viewshed; and
generating a decision to install the base-station at the identified site location based on the indication.

18. The non-transitory computer readable storage media of claim 17, wherein identifying the site location as the candidate for the base-station installation comprises an owner of the site location signing up to install the base-station, wherein the site owner signing up comprises:
selecting a base-station position within each site location;
computing a viewshed vector representing the site location and all corresponding possible site locations within the viewshed, based on the selected base-station position within each site location;
generating a viewshed matrix comprising the respective computed viewshed vectors representing each site location;
ranking the site locations using the viewshed matrix;
identifying potential site owners based on a ranking of the viewshed of the site locations;
sending marketing information to the identified potential site owners; and
receiving sign-up information from at least one of the identified potential site owners.

19. The non-transitory computer readable storage media of claim 17, wherein computing the area of the rooftop of the at least one customer location that is included in the generated viewshed comprises:
receiving rooftop area information for the at least one customer location;
generating a shape of an intersection of the viewshed and rooftop area for the at least one customer location;
computing an area for the shape; and
wherein indicating the at least one customer location as able to be served by the base-station based on the area of the rooftop at the at least one customer location that is included in the generated viewshed comprises indicating the at least one customer location as able to be served by the base-station based on the computed area for the shape.

20. The non-transitory computer readable storage media of claim 17, further comprising:
receiving a sign-up request containing the identified site location;
retrieving the indication of the at least one customer location as able to be served by the base-station for the identified site location contained in the received sign-up request; and
responding to the sign-up request with an offer statement, responsive to the generation of the decision to install the base-station at the identified site location based on the indication.
